(19) United States
(12) Patent Application Publication
(10) Pub. No.: US 2009/0164394 A1
(43) Pub. Date: Jun. 25, 2009

(54) AUTOMATED CREATIVE ASSISTANCE

(75) Inventors: Boyd Cannon Multerer, Redmond, WA (US); James M. Alkove, Bellevue, WA (US); Zachary Lewis Russell, Bellevue, WA (US); Jon Marcus Randall Whitten, Sammamish, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 11/961,100

(22) Filed: Dec. 20, 2007

(51) Int. Cl. G06F 15/18

(52) U.S. Cl. 706/12

(57) ABSTRACT

The claimed subject matter provides a system and/or a method that facilitates generating a suggestion for a creative work. An interface component can receive a portion of a creative work. A muse component can evaluate the portion of the creative work utilizing a machine learning technique, wherein the muse component can identify a portion of suggested content based upon the evaluation. A palette can be populated with the portion of suggested content, wherein the portion of suggested content is a subset of content that is available for incorporation into the creative work.

### BACKGROUND

Technological advances associated with computers, the Internet and the World Wide Web have enabled users to instantly access a vast and diverse amount of information. As compared to traditional libraries or encyclopedias, information provided by way of the Web is decentralized in nature. Furthermore, computer and networking advancements have transformed computers from rare, expensive, and low performance data processing machines to commonplace, low-cost, and efficient tools. These technological evolutions have further contributed to the constant and rapid growth of electronic data. For example, users typically access and/or view massive amounts of data while using a computer (with or without the Internet, networking, third-party networked services, etc.) such as web sites, forums, email, images, web services, web applications, video files, audio files, instant messaging services, documents, presentations, and the like.

In particular, use of such technological advancements has started to spread into atypical areas that are not known for being technologically savvy such as the creative arts (e.g., art, music, photography, literature, games, etc.). For example, musicians are increasingly using synthesizers, drum machines, mixing boards, amplifiers, sound effects, distortions, sound machines, and the like in regards to creating or editing music. Additionally, photographers are enhancing photos more and more with applications and/or software while spending less time in a dark room developing or enhancing photos. In still another example, a large majority of creative artists capture creative works with computers, recording devices, digital cameras, and the like in order to efficiently communicate such works around the globe.

However, with creative works being mostly a subjective field, wherein one person can adore one piece of work while another person can dislike the same piece of work, creative artists are finding it extremely difficult and stressful to create original and popular art. Although most artists receive guidance from professors, peers, family, and friends, most artists fail to get a general and unbiased opinion or direction for their works. In other words, typical resources for a creative artist to produce successful pieces of art have slowly become ineffective.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate examining a portion of creative work to generate a palette with at least one suggestion that can be incorporated into the creative work. A muse component can receive a portion of a creative work via an interface component, wherein the portion of creative work can be evaluated in order to identify a suggestion or suggested content that can e incorporated or included into the portion of creative work. Moreover, the muse component can populate the suggestion or the suggested content into a palette in order to allow a creator of such creative work to choose whether or not to incorporate such data. The muse component can automatically and dynamically identify suggestions, tips, content, and the like for a portion of received creative work in order to enhance production. By populating a palette with identified suggestions and/or suggested content, the muse component enables a user or creator to subjectively identify which content to incorporate or use with the creative work.

The muse component can evaluate the portion of creative work utilizing machine learning techniques, algorithms, and the like. In general, the muse component can leverage a data store that can include user opinions or suggestions, creative works, and/or any suitable combination thereof For example, suggestions or suggested content can be identified based on identifying similarities, relevancy, patterns, compatibilities, etc. between the received creative work and user opinions and/or disparate creative works. Furthermore, the muse component can employ a filter component that can enable filtering of the real time analysis of the creative work.

In accordance with an aspect of the subject innovation, the muse component can utilize a manifest component that can track metadata associated with the creative work. In general, the manifest component can generate a manifest that can include various metadata that can be representative of data contributions to the creative work. The manifest component can further allow tracking and/or monitoring of at least one of a copyright for a portion of the creative work or a license for a portion of the creative work. The muse component can additionally include a review component that can provide an automated review based at least in part upon the metadata tracked. In other aspects of the claimed subject matter, methods are provided that facilitate analyzing a portion of creative work to identify a relevant suggestion that can be utilized for the creative work based on a creator's preference.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates examining a portion of creative work to generate a palette with at least one suggestion that can be incorporated into the creative work.

FIG. 2 illustrates a block diagram of an exemplary system that facilitates leveraging a data store to aid in providing a suggestion on a palette that can be utilized for a portion of creative work.

FIG. 3 illustrates a block diagram of an exemplary system that facilitates personalizing a palette of suggestions received in real time.

FIG. 4 illustrates a block diagram of an exemplary system that facilitates tracking metadata related to a creative work to enable automated review.

FIG. 5 illustrates a block diagram of exemplary system that facilitates querying data related to suggestions and/or creative works.

FIG. 6 illustrates a block diagram of an exemplary system that facilitates analyzing a portion of creative work to identify a relevant suggestion that can be utilized for the creative work based on a creator's preference.

FIG. 7 illustrates an exemplary methodology for examining a portion of creative work to generate a palette with at least one suggestion that may improve such creative work.

FIG. 8 illustrates an exemplary methodology that facilitates tracking metadata related to a creative work to enable automated review.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “store,” “cloud,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

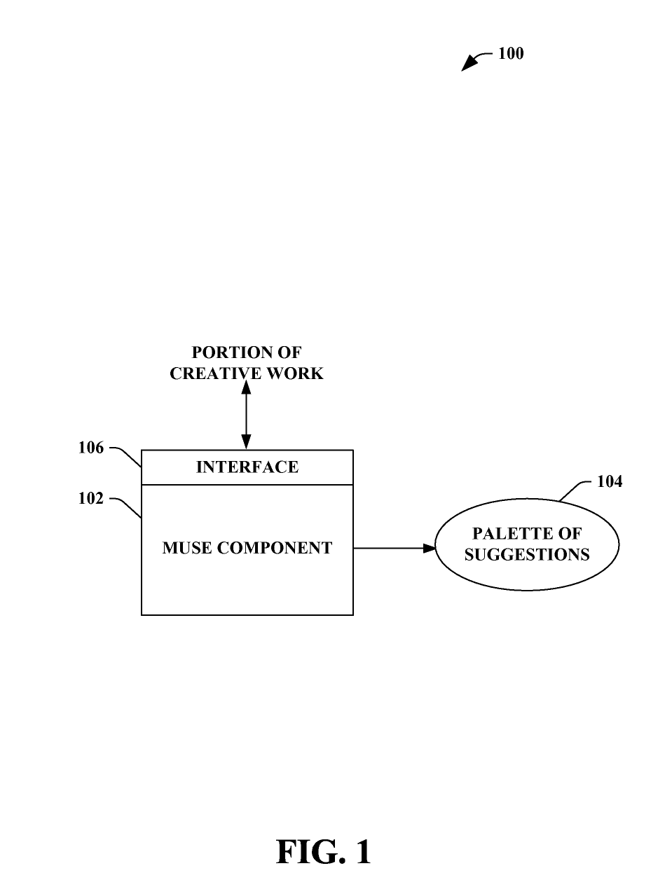

Now turning to the figures, FIG. 1 illustrates a system 100 that facilitates examining a portion of creative work to generate a palette with at least one suggestion that can be incorporated into the creative work. The system 100 can include a muse component 102 that can receive a portion of a creative work and generate a palette of suggestions 104, wherein the suggestions can be restricted in comparison to various options available for the creative work. In general, the muse component 102 can provide creative tips and/or suggestions in which the palette 104 can display such identified relevant information to allow a creative work creator/artist to incorporate accordingly. It is to be appreciated that the palette 104 can be populated with a restricted list of suggestions or tips in which a user can determine to include or not include, thereby keeping the user's subjectivity intact.

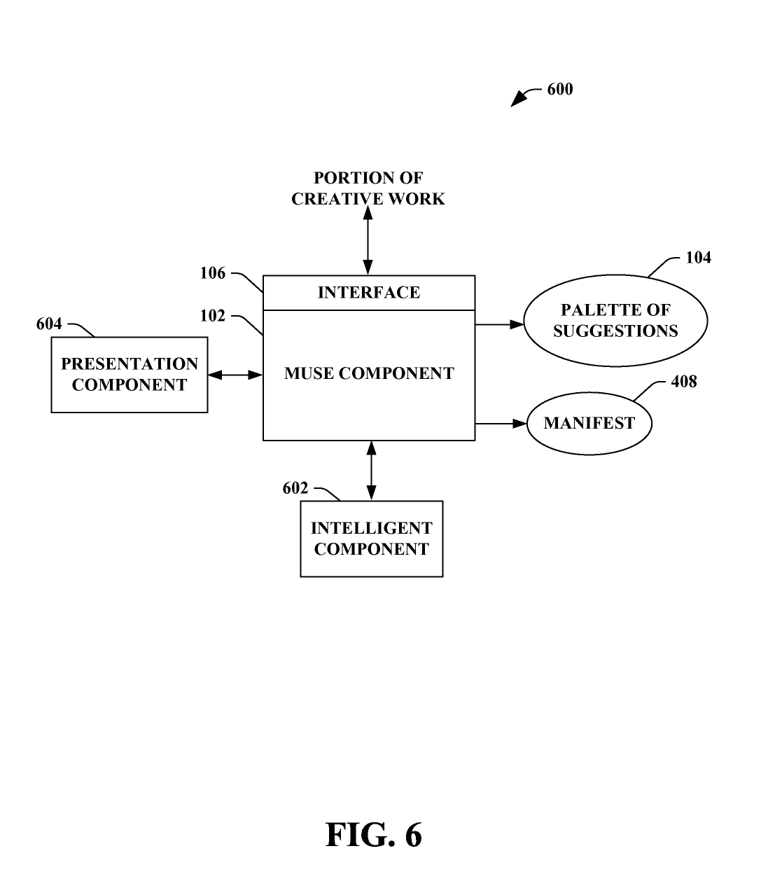

For instance, a portion of a painting (e.g., a creative work) can be received and dynamically examined by the muse component 102. The muse component 102 can utilize various machine learning techniques (e.g., discussed in more detail in FIG. 6) in order to identify various suggestions or content that can be a subset of potential options or content that can be incorporated into the creative work. In particular, the muse component 102 can generate a palette with potential color suggestions for the painting, wherein the color suggestions can be a subset of potential options (e.g., available colors, etc.) for such painting. In general, the muse component 102 can generate a palette with a subset of available options or content related to creating the creative work in progress in a dynamic manner. It is to be appreciated and understood that the creative work can be any suitable artistic expression, such as, but not limited to, a portion of literature (e.g., a poem, a story, a novel, a lyric, a limerick, etc.), a portion of music (e.g., sheet music, an instrument, a beat, a count, a measure, a chorus, a meter, etc.), a piece of art (e.g., a painting, a sculpture, a textile, etc.), a clothing design (e.g., a shirt, a pattern, a shoe, a belt, etc.), a photograph, etc. Thus, the palette of suggestions 104 can be a subset of available options or content for the particular portion of creative work.

In another example, the muse component 102 can be utilized with an application or hardware associated with creating or generating creative works. The application or hardware can employ a first palette related to available options (e.g., content such as words, lyrics, instruments, beats, colors, etc.) that can be incorporated into a creative work. In addition, the muse component 102 can provide a second palette with at least one suggested option (e.g., a subset of available options or content, etc.) for the creative work dynamically identified based on a progress of the creative work. For instance, a digital painting application can include a first palette of available colors, wherein a second palette can include color suggestions in a restricted manner (e.g., a subset of available colors, etc.). In still another example, a music compilation software or hardware can include a first palette of available options (e.g., effects, instruments, samples, etc.), wherein a second palette can be provided with at least one suggestion. Moreover, it is to be appreciated that the palette of suggestions 104 can be dynamically updated in accordance with a progress of the creative work. Thus, if a user adds a first color to a painting, a palette of suggestions can be provided and upon addition of another color to the painting, the palette of suggestions can be updated accordingly.

In addition, the system 100 can include any suitable and/or necessary interface component 106 (herein referred to as “interface 106”), which provides various adapters, connectors, channels, communication paths, etc. to integrate the muse component 102 into virtually any operating and/or database system(s) and/or with one another. In addition, the interface 106 can provide various adapters, connectors, channels, communication paths, etc., that provide for interaction with the muse component 102, the restricted palette of suggestions, a portion of creative work, and any other device and/or component associated with the system 100.

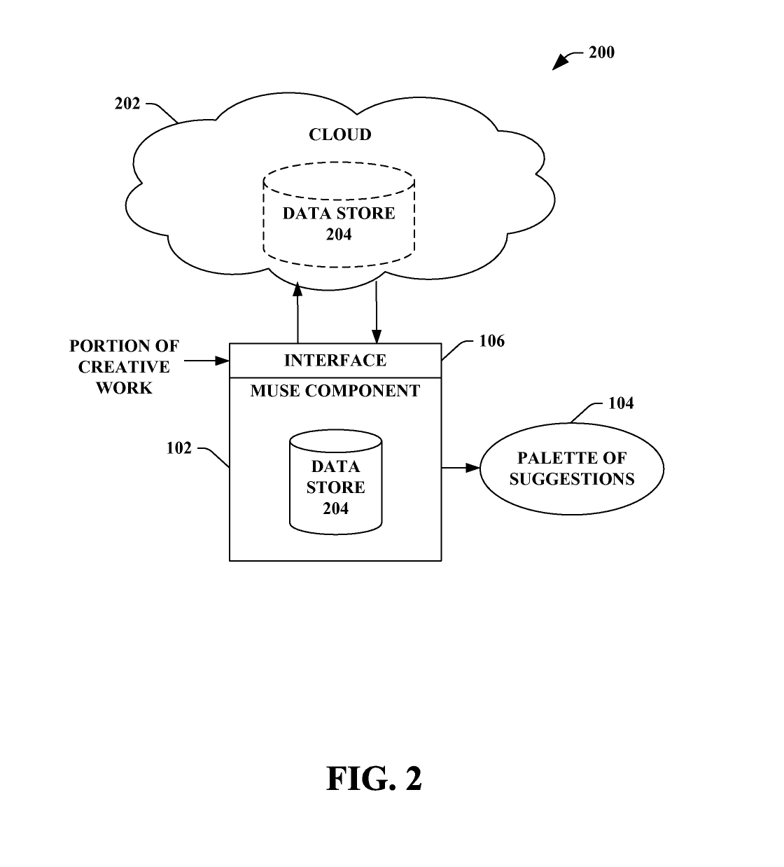

FIG. 2 illustrates a system 200 that facilitates leveraging a data store to aid in providing a suggestion on a palette that can be utilized for a portion of creative work. The muse component 102 can provide creative suggestions in order to give an artist available options or guidance in creating a creative work. The muse component 102 can facilitate identifying suggestions from available options for a particular creative work, wherein such suggestions can be populated onto the palette of suggestions 104. For example, a portion of a poem can be received by the interface 106 in which the muse component 102 can evaluate in order to identify corresponding and/or relevant suggestions. Such suggestions can populated onto the palette of suggestions 104 and can be a subset of available options/suggestions. For instance, the palette can include specific word selections, phrases, rhyming words, etc. that can assist in creating the poem. In general, the palette of suggestions 104 can be a tool for guidance and/or suggestions in which an artist can select for incorporation or use.

The system 200 can further utilize a cloud 202 that can incorporate a data store 204 (e.g., discussed in more detail below). However, it is to be appreciated that the cloud 202 can incorporate the interface 106, the muse component 102, the data store 204, and/or any suitable combination thereof The cloud 202 can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). The cloud 202 is intended to include any service, network service, cloud service, collection of resources, etc. and can be accessed by an identified user via a network. In addition, the cloud 202 can provide any suitable number of service(s) to any suitable number of user(s) and/or client(s). In particular, the cloud 202 can include resources and/or services that generate a palette of suggestions for the specifically received portion of creative work. For instance, the muse component 102 can be incorporated into the cloud 202 which can push and/or pull information (e.g., suggestions, palette, etc.) to a user, a device, a machine, and/or any other suitable entity.

The system 200 can further include a data store 204 that can include any suitable data related to the muse component 102, the portion of creative work, the palette of suggestions 104, the interface, the cloud 202, etc. It is to be appreciated that the data store 204 can be a local data store (e.g., incorporated into a machine, device, computer, etc.), a remote data store (e.g., located on the Internet, a network, a server, the cloud 202, etc.), and/or any suitable combination thereof. For example, the data store 204 can include, but not limited to including, content for creative works, suggestions, options for a creative work, machine learning techniques/algorithms, creative work, expert opinions or suggestions, opinions from a user with corresponding skill level of the creator of the work, historic data in relation to creative works, user settings, user profiles, configurations, cloud 202 data, passwords, account information, and/or any other suitable data related to the system 200.

It is to be appreciated that the data store 204 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 204 of the subject systems and methods is intended to comprise, without being limited to, these and any other suitable types of memory. In addition, it is to be appreciated that the data store 204 can be a server, a database, a hard drive, a pen drive, an external hard drive, a portable hard drive, and the like.

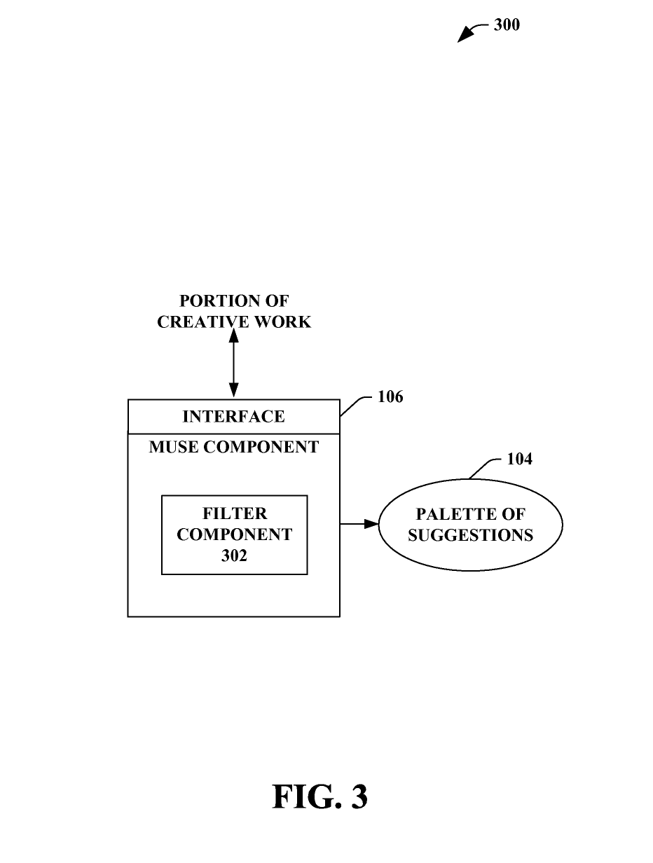

FIG. 3 illustrates a system 300 that facilitates personalizing a palette of suggestions received in real time. The system 300 can include the muse component 102 that generates suggested content related to a portion of creative work, wherein the suggested content can be populated and/or aggregated onto the palette of suggestions 104. In general, the muse component 102 can provide creative suggestions of content for the particular portion of creative work in which a creator of such work can opt to use such suggestions. For instance, a portion of music such as a drum beat can be received by the interface 106. The muse component 102 can evaluate such drum beat in order to identify suggested content that correlates to the received drum beat. For example, the evaluation can be at least one of frequency analysis, machine learning techniques to identify compatibility, type of instrument, a user-defined genre desired for the creative work, user-defined goal for the creative work (e.g., type of music, feel of music, mood of music, etc.), expert analysis and/or feedback, opinions from a user with corresponding skill level of the creator of the work, etc. Based on the evaluation, the muse component 102 can provide a palette including content that is suggested, wherein such suggested content is a subset of the large amount of content or available options that can be incorporated into the creative work. Thus, the palette can be utilized to facilitate identifying and/or selecting a portion of content or options to apply to a creative work in progress.

The system 300 can further include a filter component 302 that can employ filtering against real time analysis. The filter component 302 can allow the identified suggestive content to be further filtered based upon a user or artist personal preference. For example, a user can be working on a sample of music that is a work in progress. The system 300 can evaluate the sample of music to dynamically identify at least one suggestion or portion of content that can be populated into the palette 104 without the user having to perform a manual search for content or suggestions that are compatible. However, the filter component 302 can narrow or broaden the automated search that identifies suggestions or content that can be populated onto the palette 104. Thus, the user can provide various criteria in which to personalize identified suggestions or content for a received portion of creative work. For example, the criteria can include genre of creative work (e.g., poem, literature, jazz, riddle, etc.), type of creative work (e.g., sculpture, painting, music, etc.), type of content (e.g., instrument, words, colors, materials for work, rhymes, etc.), mood associated with the creative work (e.g., happy, sad, gloomy, angry, etc.), a search term, a user-defined criteria, and/or any other suitable criteria that can broaden or narrow identified suggestions or content.

In accordance with another aspect of the subject innovation, the filter component 302 can filter the data store information utilized to identify patterns, relevancy, compatibility, and the like. For instance, a data store of creative works can be filtered to limit the identified suggestions or content. In one example, the muse component 102 can utilize a filtered set of data (e.g., creative works) based on user-defined criteria. Thus, a painter can limit or expand the creative works analyzed to identify patterns, relevancy, compatibility, and the like based on a specific artist or period of time. Moreover, the filter component 302 can allow data store information to be filtered based on criteria associated with expert opinions, suggestions, or content. For instance, a particular user may filter expert data that can be returned based on a level of experience or area of expertise.

The muse component 102 can be a creative aid that augments creative works in a collaborative manner with other forms of content. This can include offering suggestions to complete a song, providing alternative arrangements, coding sounds into sheet music, offering lyrical suggestions, showing different perspectives or colors on paintings, and/or any other suitable type of automated assistance to facilitate further creative development. For example, a guitar player can hear a riff in their mind and record the riff which is saved to a database. Based upon automated analysis, the muse component 102 can generate creative suggestions from the database. In one instance, these could be providing similar compositions or genres, completing the riff, rearranging the riff, mixing the riff with other instruments and the like.

Moreover, the muse component 102 can provide other instrumentation or recorded vocalizations to supplement or augment a given creative work. It is to be appreciated that the augmentations can be applied to other creative venues such as, but not limited to, a drawing or sculpture in which suggestions can be provided based on the present work and an association with other saved data content related to a data store (discussed above). Furthermore, the muse component 102 can employ a sounds-like feature, wherein a given snippet or portion of creative work can be selected in which a related work can be retrieved and presented. For example, this can include showing musical album covers and snippet data such as what inspired a particular artist to create a given audio file.

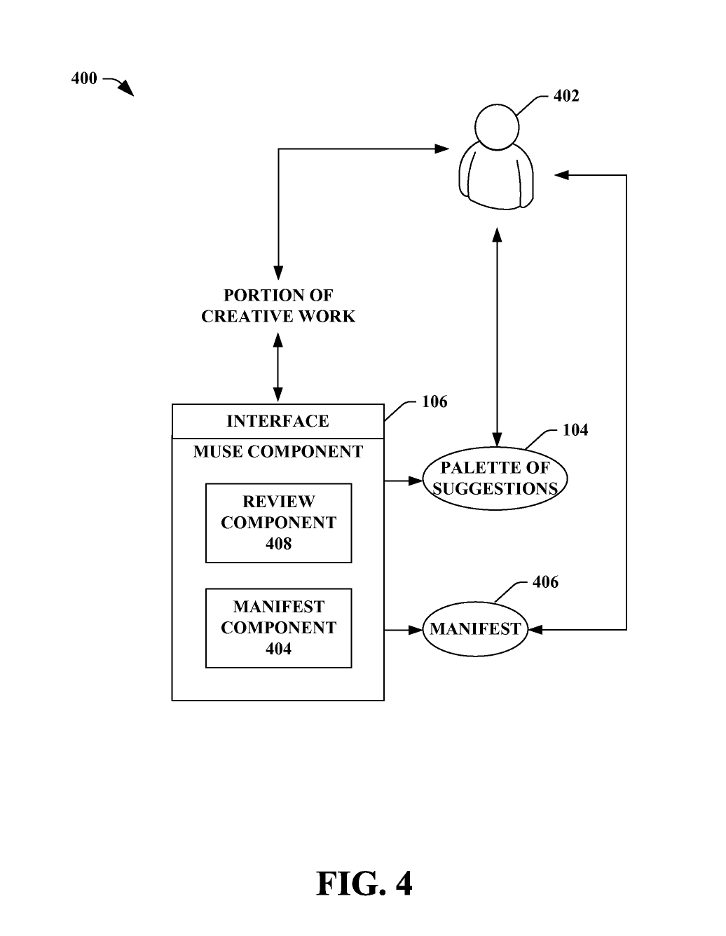

FIG. 4 illustrates a system 400 that facilitates tracking metadata related to a creative work to enable automated review. The system 400 can evaluate a portion of creative work (received via the interface 106) in order to identify at least one creative suggestion or portion of content that can be populated into the palette of suggestions 104. Such palette of suggestions 104 can be presented to a user 402 to allow a choice whether or not to include or utilize such suggestions or content. It is to be appreciated that the palette 104 can be any suitable graphical overlay or portion of graphic that can display and/or communicate the suggestions and/or suggested content to the user 402, machine, entity (e.g., company, group, business, enterprise, etc.), etc.

For example, the user 402 can submit a portion of creative work to the muse component 102, wherein such portion can be examined in order to identify characteristics, patterns, and the like utilizing various automated evaluation techniques. Based on such examination, a suggestion or suggested content can be identified and populated to the palette 104 to display or communicate to the user 402. It is to be appreciated that the palette 104 can be dynamically populated as the user 402 creates the creative work. Thus, as the user 402 is creating the creative work, suggestions or suggested content can be presented to the user 402 for use or incorporation based on his or her desire.

The muse component 102 can employ a manifest component 404 that can track various metadata associated with the creative work. In particular, the manifest component 404 can monitor and/or record metadata related to contributions, suggestions, suggested content, and the like. For example, a creative work can be created utilizing user-originated data (e.g., data incorporated based on the creator's preferences, etc.) and/or suggested content or data (e.g., data generated by the muse component 102 based on evaluation of such creative work, etc.). The manifest component 404 can create a log that can include contribution related metadata, wherein such metadata can track information related to a creative work. It is to be appreciated that the tracked information can be such as, but not limited to, amount of user-originated data, time metadata collected, source content, copy-right owner, origin of incorporated data, contribution metadata, any other suitable data related to historic incorporations related to the creative work. In general, the manifest component 404 can generate a manifest 406 that can be presented to the user 402. In still another example, the manifest component 404 can include information related to copyrights, licenses, and/or other royalties for contributions included into the creative work. In other words, the manifest can track the copyright holders for the incorporated suggested data or content to allow the user 402 to ensure licensing fees have been paid or the use of such data or content in the creative work is not violating a copyright.

The muse component 102 can further include a review component 408 that can provide an automated review for the creative work or a portion of the creative work. For example, the review component 408 can provide an automated review based at least in part upon at least one of the manifest 408, the metadata tracked by the manifest component 404, and/or any other suitable data associated with creating the creative work. In general, the review component 408 can automatically review the creative work based at least in part upon content of the manifest 406 in order to provide review or critiques on creative works with metadata collected in a standardized manner. In one example, a user can produce a creative work in which a manifest can include contribution related metadata that tracks content incorporated into such work. The user can submit such creative work for an automated review based on the content of the manifest. The review can provide information such as percentage of suggested content, time stamps, contributors, origin of incorporated content, time duration for completion of work, copyright information, licensing information, and/or any other suitable automated review utilizing the metadata tracked by the manifest component 404.

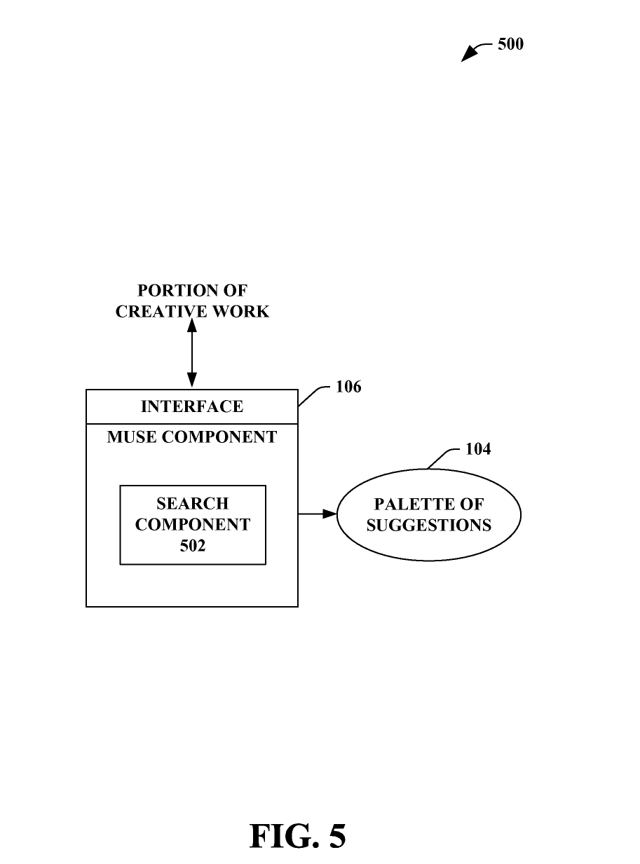

FIG. 5 illustrates a system 500 that facilities querying data related to suggestions and/or creative works. The system 500 can include the muse component 102 that can automatically and dynamically identify relevant suggestions or content for a portion of a creative work in progress based upon evaluation of such patterns, characteristics and/or any other suitable creative work information. For example, a poem can be evaluated by the muse component 102 in which a pattern such as a word meter, word rhyming scheme, or type of poem can be identified in order to identify a creative suggestion or a suggested portion of content. By identifying a creative suggestion or a suggested portion of content for the poem, the system 500 can facilitate creating creative works while still keeping an artist's subjectivity and creative spirit intact.

The muse component 102 can further utilize a search component 502 that facilitates querying any data associated with the system 500. The search component 502 allows a user and/or any component to query to system 500 in relation to creative works, a remote data store, a local data store, a data store including expert suggestions/content, a data store including opinions from a user with corresponding skill level of the creator of the work, a data store including creative works, previous suggestions or suggested content, etc. Furthermore, the search component 502 can provide various search criteria for broadening or limiting search results to enhance data querying. For instance, a user can query the system 500 utilizing the search component 502 to find a creative work of a specific type produced during a certain time period. In another example, the search component 502 can return a search result in connection with a query related to a specific user's creative works. In another example, a user can utilize the search component 502 to identify at least one suggestion identified for a specific portion of creative work. It is to be appreciated that a plurality of searches and/or queries can be implemented by the search component 502 and the above examples are not to be limiting on the claimed subject matter. Moreover, it is to be appreciated that the search component 502 is depicted as being incorporated into the muse component 102, but the search component 502 can be a stand-alone component, incorporated into the muse component 102, and/or any suitable combination thereof.

FIG. 6 illustrates a system 600 that employs intelligence to facilitate analyzing a portion of creative work to identify a relevant suggestion that can be utilized for the creative work based on a creator's preference. The system 600 can include the muse component 102, the palette of suggestions 104, the interface 106, the manifest 408, and/or the portion of creative work. It is to be appreciated that the muse component 102, the palette of suggestions 104, the manifest 408, and/or the portion of creative work can be substantially similar to respective components, palettes, manifests, and creative works described in previous figures. The system 600 further includes an intelligent component 602. The intelligent component 602 can be utilized by the muse component 102 to facilitate automatically and dynamically evaluating the portion of creative work to identify and populate a palette with at least one suggestion or portion of content related to the creative work in progress. For example, the intelligent component 602 can infer a suggestion, a portion of content to incorporate into a creative work, a user preference, a user configuration, a genre, a criteria of search for a user, a characteristic of a creative work (e.g., time period, a mood, a topic, a type of work, etc.), a filter, an expert suggestion, an opinion from a user with corresponding skill level of the creator of the work, a characteristic for a user based on previous creative works, a search term, etc.

The intelligent component 602 can employ value of information (VOI) computation in order to identify suggestions and/or inferred content for a creative work. For instance, by utilizing VOI computation, the most ideal and/or appropriate suggestions and/or content can be determined. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The muse component 102 can further utilize a presentation component 604 that provides various types of user interfaces to facilitate interaction between a user and any component coupled to the muse component 102. As depicted, the presentation component 604 is a separate entity that can be utilized with the muse component 102. However, it is to be appreciated that the presentation component 604 and/or similar view components can be incorporated into the muse component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the muse component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

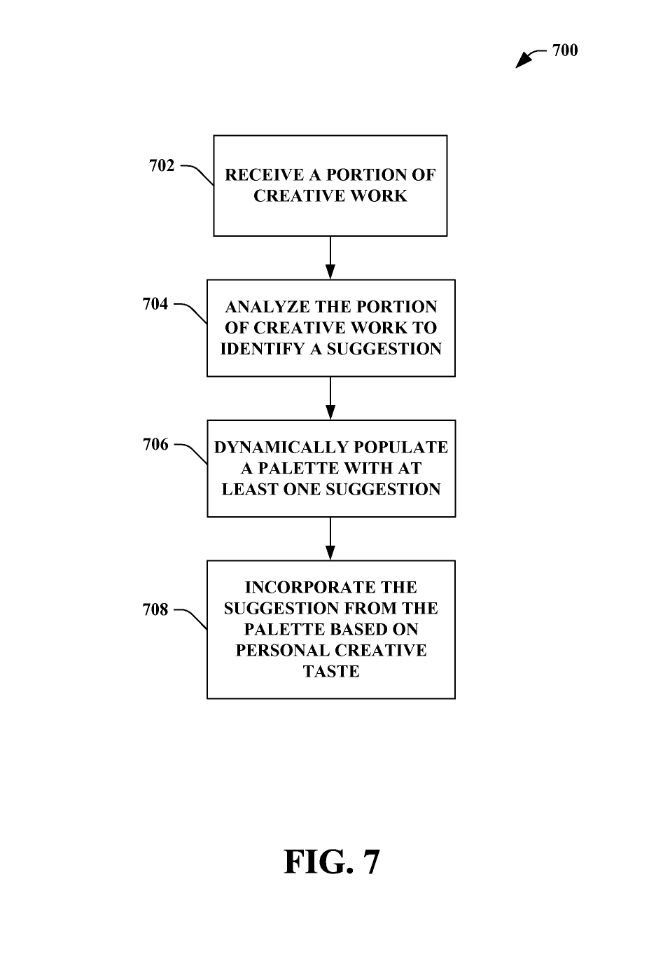

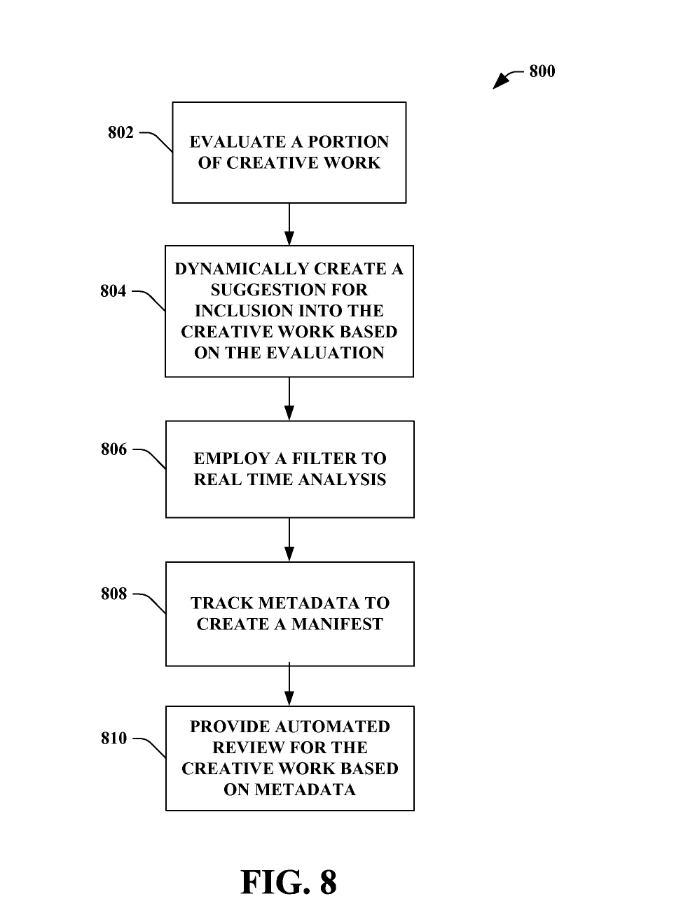

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates examining a portion of creative work to generate a palette with at least one suggestion that may improve such creative work. At reference numeral 702, a portion of a creative work can be received. The portion of creative work can be a completed work, a work in progress, and/or any suitable combination thereof It is to be appreciated and understood that the creative work can be any suitable artistic expression, such as, but not limited to, a portion of literature (e.g., a poem, a story, a novel, a lyric, a limerick, etc.), a portion of music (e.g., sheet music, an instrument, a beat, a count, a measure, a chorus, a meter, etc.), a piece of art (e.g., a painting, a sculpture, a textile, etc.), a clothing design (e.g., a shirt, a pattern, a shoe, a belt, etc.), a photograph, etc.

At reference numeral 704, the portion of creative work can be analyzed. The portion of creative work can be analyzed utilizing any suitable automotive technique such as machine learning, inference techniques, and the like. Based upon the analysis, a suggestion can be identified for the portion of creative work. In particular, the suggestion can be any suitable option or content that can be incorporated into the creative work that is compatible or relevant based on such analysis. Moreover, the suggestion can be identified based upon the analysis in combination with at least one of a data store including previous creative works, a data store including an expert or user opinions/suggestions, and/or any suitable combination thereof

At reference numeral 706, a palette can be dynamically updated with at least one suggestion based upon the analysis. It is to be appreciated that the palette 104 can be any suitable graphical overlay or portion of graphic that can display and/or communicate the suggestions and/or suggested content to the user 402, machine, entity (e.g., company, group, business, enterprise, etc.), etc. At reference numeral 708, the suggestion can be incorporated from the palette into the creative work based on personal creative taste. In other words, an artist, user, or creator can decide whether or not to incorporate or utilize the generated suggestion or suggested content based upon his or her personal taste. For instance, a first palette can include options and/or available content to utilize in connection with a creative work, wherein a second palette can include a subset of such available content or options that have been identified as relevant or compatible suggestions.

FIG. 8 illustrates a method 800 for tracking metadata related to a creative work to enable automated review. At reference numeral 802, a portion of creative work can be evaluated. At reference numeral 804, a suggestion can be dynamically created for inclusion into the creative work, wherein the suggestion is created based on the evaluation of the creative work. For example, a drum beat can be evaluated utilizing machine learning (e.g., frequency analysis, etc.) in order to identify a suggestion or suggested content that is compatible, relevant, and/or matches the particular drum beat. In another example, a palette can be populated with the identified suggestions or suggested content to enable a user to select and incorporate such data at will.

At reference numeral 806, a filter can be employed for real time analysis. For example, the identified suggestions or suggested content can be filtered (e.g., narrow a search, broaden a search, etc.) based on personal preferences of a creator of the creative work. For instance, suggestions or suggested content can be dynamically adjusted based on criteria identified by a user. The criteria can be, but is not limited to, genre of creative work (e.g., poem, literature, jazz, riddle, etc.), type of creative work (e.g., sculpture, painting, music, etc.), type of content (e.g., instrument, words, colors, materials for work, rhymes, etc.), mood associated with the creative work (e.g., happy, sad, gloomy, angry, etc.), a user-defined criteria, and/or any other suitable criteria that can broaden or narrow identified suggestions or content.

At reference numeral 808, metadata related to the creative work can be tracked to create a manifest. In particular, metadata related to contributions, suggestions, suggested content, and the like can be logged. For example, a creative work can be created utilizing user-originated data (e.g., data incorporated based on the creator's preferences, etc.) and/or suggested content or data (e.g., data generated based on evaluation of such creative work, etc.). Moreover, the metadata can be related to an amount of user-originated data, a time the metadata had been collected, the source of the incorporated content, the copy-right owner of such incorporated data, an origin of incorporated data, contribution defining metadata, any other suitable data related to historic incorporations related to the creative work. In addition, the metadata can be utilized to ensure data utilized with a creative work is properly and legally used in regards to copyrights and licensing. At reference numeral 810, an automated review can be provided for the creative work based at least in part upon the metadata tracked.

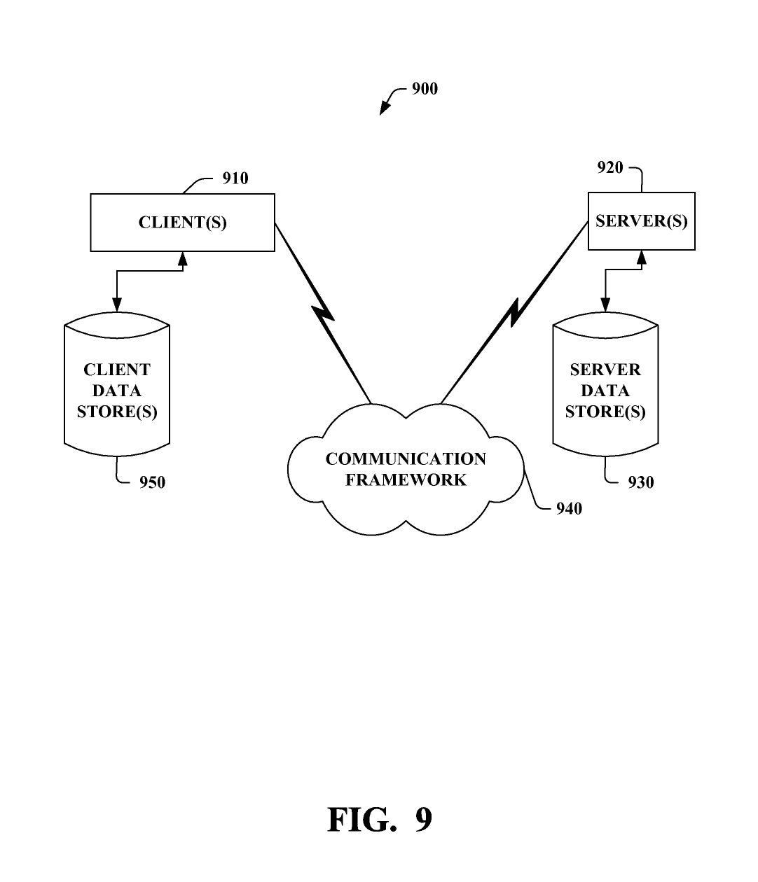

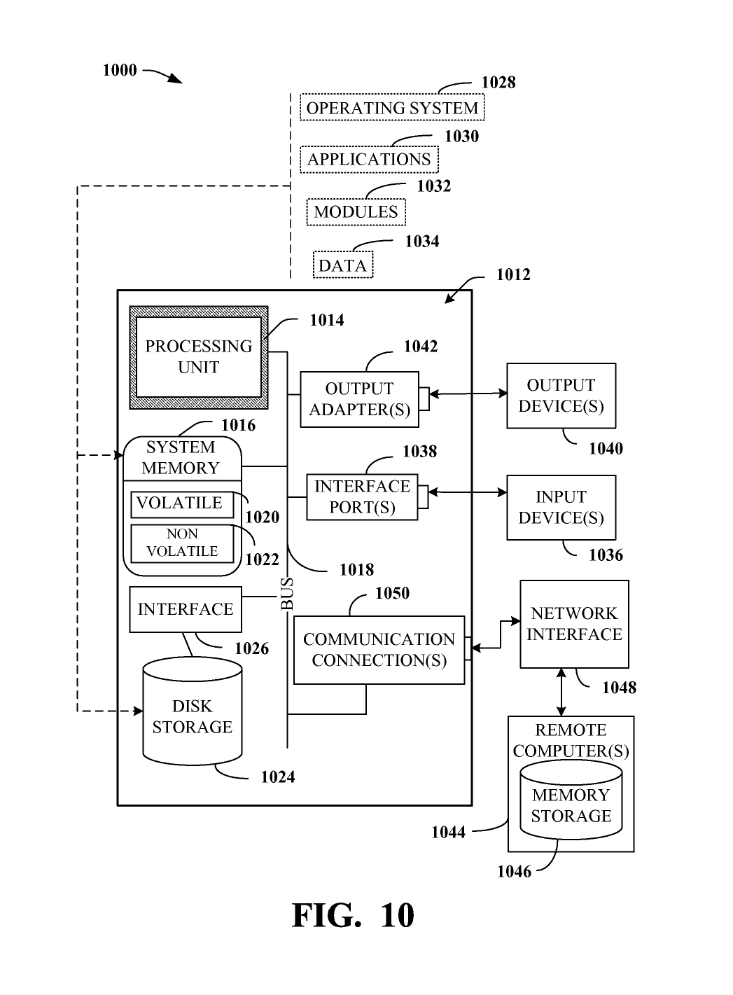

In order to provide additional context for implementing various aspects of the claimed subject matter, FIGS. 9-10 and the following discussion is intended to provide a brief, general description of a suitable computing environment in which the various aspects of the subject innovation may be implemented. For example, a muse component that facilitates identifying a suggestion or content for a creative work, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates generating a suggestion for a creative work, comprising:
an interface component that receives a portion of a creative work;
a muse component that evaluates the portion of the creative work utilizing a machine learning technique, the muse component identifies a portion of suggested content based upon the evaluation; and
a palette that is populated with the portion of suggested content, the portion of suggested content is a subset of content that is available for incorporation into the creative work.

2. The system of claim 1, the portion of the creative work is at least one of an artistic expression, a portion of literature, a portion of music, a piece of art, a clothing design, or a photograph.

3. The system of claim 1, the palette is automatically and dynamically populated based at least in part upon the portion of the creative work evaluated.

4. The system of claim 1, the muse component examines at least a portion of a creative work previously created to identifying the suggested content.

5. The system of claim 1, the muse component examines at least one suggestion related to a user opinion on the portion of the creative work, the user skill-level corresponds to a creator of the portion of the creative work.

6. The system of claim 1, the muse component is utilized with at least one of an application or a portion of hardware associated with generating a portion of a creative work.

7. The system of claim 1, the muse component leverages at least one data store to identify the suggested content, the data store includes at least one of a portion of data related to a user suggestion, a portion of data related to a creative work, or a combination of a portion of data related to a user suggestion and a portion of data related to a creative work.

8. The system of claim 7, the data store is at least one of a remote data store, a local data store or a combination of a local data store and a remote data store.

9. The system of claim 1, further comprising a cloud that hosts at least one of the muse component, the data store, the interface component, or a combination of the muse component, the data store, and the interface component.

10. The system of claim 9, the cloud is at least one resource that is maintained by a party and accessible by an identified user over a network.

11. The system of claim 1, further comprising a filter component that employs real time filtering for the evaluation of the portion of the creative work.

12. The system of claim 11, the filtering is based at least in part upon at least one user-defined criterion.

13. The system of claim 11, the criterion is at least one of a genre of creative work, a type of creative work, a type of content, a mood associated with the creative work, or a search term.

14. The system of claim 1, further comprising a manifest component that tracks a portion of metadata related to the portion of the creative work, the portion of metadata relates to a contribution to creating the creative work.

15. The system of claim 14, the manifest component tracks metadata associated with at least one of a copyright of an included suggested content, or a license for an included content.

16. The system of claim 14, further comprising a review component that implements an automated review for the portion of the creative work based at least in part upon the portion of metadata.

17. A computer-implemented method that facilitates providing a creative suggestion for a creative work in progress, comprising:
receiving a portion of creative work in progress;
analyzing the portion of creative work;
identifying a creative suggestion for the portion of creative work based upon the analysis; and
dynamically populating a palette with the creative suggestion to allow incorporation into the creative work in progress.

18. The method of claim 17, further comprising:
utilizing a machine learning to analyze the portion of creative work; and
incorporating the creative suggestion based upon a personal preference of a creator of the portion of creative work.

19. The method of claim 17, further comprising:
employing a filter to the real time analysis of the portion of creative work;
tracking a portion of metadata associated with contributed content of the portion of creative work; and
automatically generate a review for the portion of creative work based at least in part upon the portion of metadata.

20. A computer-implemented system that facilitates generating a suggestion for a creative work, comprising:
means for receiving a portion of a creative work;
means for evaluating the portion of the creative work utilizing a machine learning technique;
means for identifying a portion of suggested content based upon the evaluation; and
means for populating a palette with the portion of suggested content, the portion of suggested content is a subset of content that is available for incorporation into the creative work.
